(19) United States
(12) Patent Application Publication
(10) Pub. No.: US 2016/0313817 A1
(43) Pub. Date: Oct. 27, 2016

(54) MOUSE PAD WITH TOUCH DETECTION FUNCTION

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YU-ZHONG FENG, Shenzhen (CN); JUN-JIN WEI, New Taipei (TW); CHENG-CHING CHIEN, New Taipei (TW); HAO-WEN CHIEN, New Taipei (TW)

(21) Appl. No.: 14/864,530

(22) Filed: Sep. 24, 2015

(30) Foreign Application Priority Data
Apr. 23, 2015 (CN) 201510196174.4

(51) Int. Cl. G06F 3/0354; G06F 3/039; G06F 3/043

(52) U.S. Cl. CPC G06F 3/03547; G06F 3/043; G06F 3/0395

(57) ABSTRACT

A mouse pad with a touch detection function includes a communication unit, a first ultrasonic unit, a second ultrasonic unit, and a processor including a detection module, a selection module, a calculating module, and a determining module, the detection module detects whether the first ultrasonic unit and second ultrasonic unit receive reflection waves, and determines that an object is touching the mouse pad when the first ultrasonic unit and second ultrasonic unit receive the reflection waves, the selection module selects a predetermined number of first reflection waves and second reflection waves, the calculating module establishes a rectangular coordinates system, and determines coordinate values of the first reflection points and second reflection points, the determining module determines the reflection points having the same coordinate value at a first predetermined interval, selects a reflection point from the determined reflection points as a detection point.

### CROSS-REFERENCE TO RELATED APPLICATIONS

This application claims priority to Chinese Patent Application No. 201510196174.4 filed on Apr. 23, 2015, the contents of which are incorporated by reference herein.

### FIELD

The subject matter herein generally relates to human interface devices, and particularly to a mouse pad with a touch detection function.

### BACKGROUND

When a user uses a mouse physically for a long time, a life time of the physical mouse would be decreased, at the same time, the user may be tired.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a block diagram of a mouse pad with a touch detection function of one embodiment.

FIG. 2 is a diagrammatic view illustrating the mouse pad being used by a user.

FIG. 3 is a diagrammatic view of reflection points on an object which is touching the mouse pad of one embodiment.

FIG. 4 is a diagrammatic view of calculating a coordinate value of a reflection point according to a coordinates system mapped to the mouse pad.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

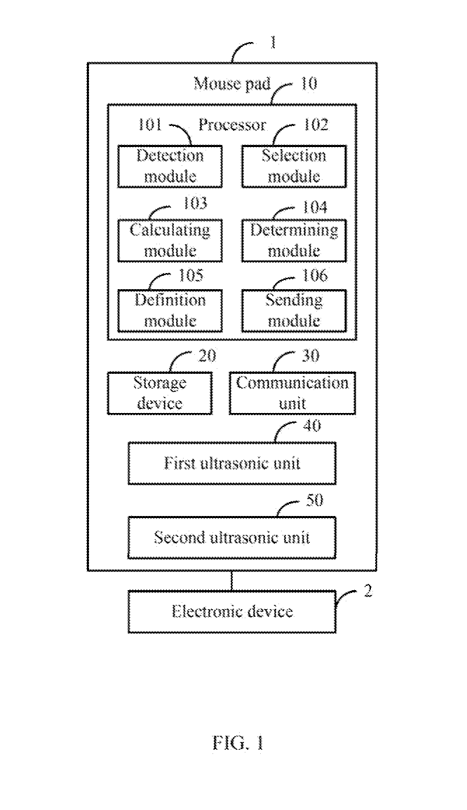

FIG. 1 illustrates a mouse pad 1 with a touch detection function. The mouse pad 1 includes, but is not limited to, a processor 10, a storage device 20, a communication unit 30, a first ultrasonic unit 40, and a second ultrasonic unit 50. FIG. 1 illustrates only one example of the mouse pad 1, other examples can include more or fewer components than illustrated, or have a different configuration of the various components in other embodiments.

The communication unit 30 is used for connecting the mouse pad 1 to an electronic device 2. In the illustrated embodiment, the communication unit 30 can be a USB data line or a USB port. The communication unit 30 connects the mouse pad 1 to the electronic device 2 by a USB port of the electronic device 2, and receives a power voltage from the electronic device 2. In other embodiments, the communication unit 30 can be a wireless transmission unit, such as Wireless Local Area Network (WLAN), Wireless Fidelity (WIFI), or BLUETOOTH. The communication unit 30 can connect the mouse pad 1 to the electronic device 2 wirelessly, and the mouse pad 1 is powered by a built-in battery. In the illustrated embodiment, the electronic device 2 can be a personal computer, such as a desktop computer or a laptop computer, or other device receiving input.

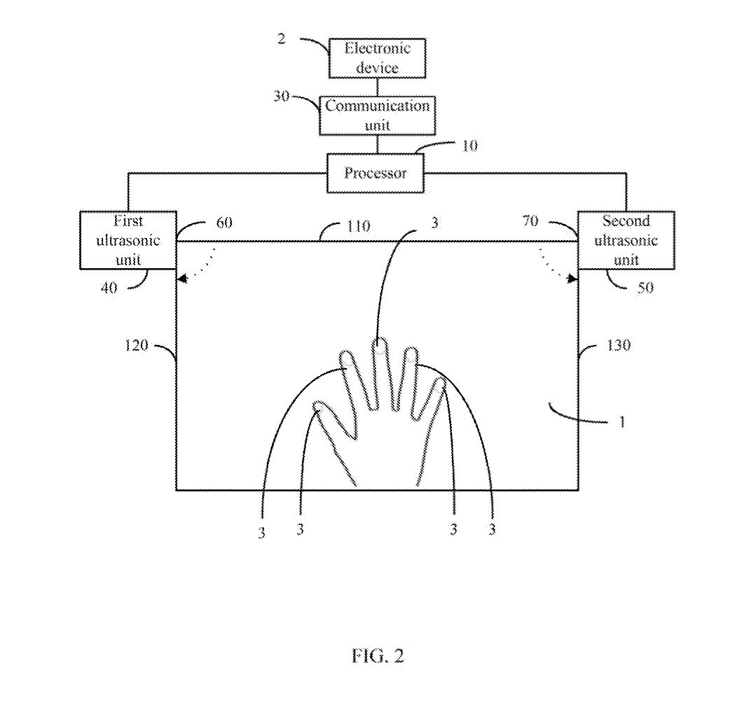

As illustrated in FIG. 2, the first ultrasonic unit 40 and the second ultrasonic unit 50 are located in two different positions of the mouse pad 1. In the illustrated embodiment, the mouse pad 1 is a rectangular pad, the first ultrasonic unit 40 and the second ultrasonic unit 50 are located at the top two corners of the mouse pad 1. For example, the first ultrasonic unit 40 is located in a first position 60 corresponding to one corner, the second ultrasonic unit 50 is located in a second position 70 corresponding to another adjacent corner.

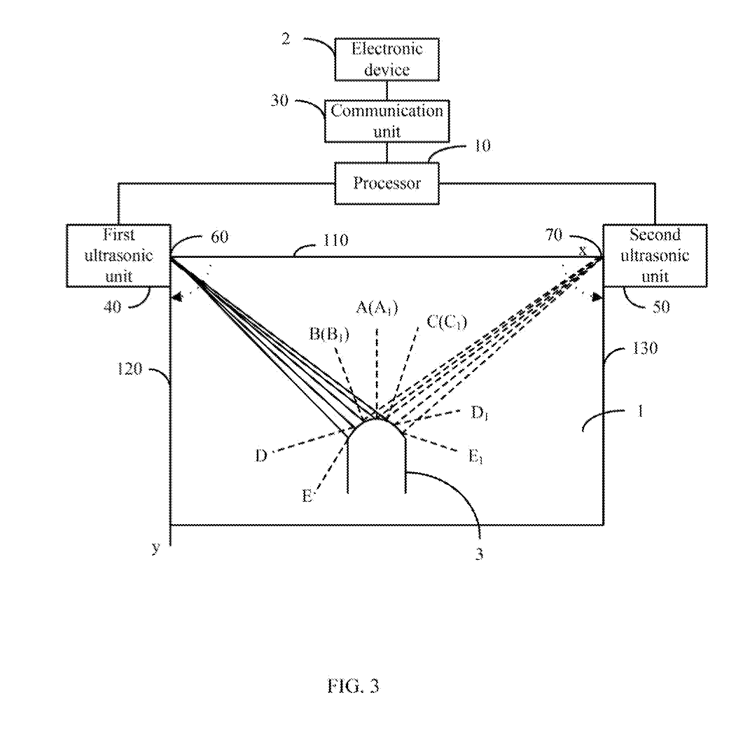

In the illustrated embodiment, the first ultrasonic unit 40 and the second ultrasonic unit 50 both are ultrasonic sensors which are used to transmit and receive ultrasonic waves. When the mouse pad 1 is connected to the electronic device 2, the first ultrasonic unit 40 transmits a first ultrasonic wave towards the mouse pad 1, and the first ultrasonic wave has a transmission angle gradually changing along a first predetermined direction periodically, for example, as shown in FIG. 3. The first ultrasonic unit 40 further receives a first reflection wave due to the first ultrasonic wave being reflected by an object 3. When the mouse pad 1 is connected to the electronic device 2, the second ultrasonic unit 50 transmits a second ultrasonic wave towards the mouse pad 1, and the second ultrasonic wave has a transmission angle gradually changing along a second predetermined direction periodically, for example, as shown in FIG. 3. The second ultrasonic unit 50 further receives a second reflection wave due to the second ultrasonic wave being reflected by the object 3.

In the illustrated embodiment, a period when the transmission angle of the first ultrasonic wave changes from a minimum angle to a maximum angle along the first predetermined direction, is equal to a period when the transmission angle of the second ultrasonic wave changes from a minimum angle to a maximum angle along the second predetermined direction. Such period can be 1 millisecond (ms). In one embodiment, the first predetermined direction is a clockwise direction, and the second predetermined direction is an anticlockwise direction.

As illustrated in FIG. 2, a side located between the first position 60 and the second position 70 is a first side 110, a side where the first position 60 is located and adjacent to the first side 110 is a second side 120, and a side opposite to the second side 120 is a third side 130. The first ultrasonic unit 40 transmits the first ultrasonic wave in a clockwise manner from the first side 110 to the second side 120 in each period, that is, the first ultrasonic unit 40 transmits the first ultrasonic wave to scan over the mouse pad 1 in each 1 ms period. The second ultrasonic unit 50 transmits the second ultrasonic wave in an anticlockwise manner from the first side 110 to the third side 130 in each 1 ms period, that is, the second ultrasonic unit 50 transmits the second ultrasonic wave to scan over the mouse pad 1 in each 1 ms period.

In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. The at least one processor 10 can be a central processing unit (CPU), a microprocessor, or other data processor chip that performs functions of the mouse pad 1.

As illustrated in FIGS. 1-2, the processor 10 is connected to the communication unit 30, the first ultrasonic unit 40, and the second ultrasonic unit 50. The processor 10 includes a detection module 101, a selection module 102, a calculating module 103, a determining module 104, a definition module 105, and a sending module 106. In the illustrated embodiment, the modules 101-106 can be collections of software instructions stored in the storage device 20 of the mouse pad 1 and executed by the processor 10. The modules 101-106 also can include functionality represented as hardware or integrated circuits, or as software and hardware combinations, such as a special-purpose processor or a general-purpose processor with special-purpose firmware.

The detection module 101 detects whether the first ultrasonic unit 40 and the second ultrasonic unit 50 receive the reflection waves. In the illustrated embodiment, the first ultrasonic unit 40 and the second ultrasonic unit 50 both include, but are not limited to, a transmitter and a receiver. The detection module 101 determines whether the first ultrasonic unit 40 and the second ultrasonic unit 50 receive the reflection waves according to whether the receivers of the first ultrasonic unit 40 and the second ultrasonic unit 50 receive ultrasonic signals.

The detection module 101 further determines that the object 3 is touching the mouse pad 1 when the first ultrasonic unit 40 and the second ultrasonic unit 50 both receive the reflection waves. When neither of the first ultrasonic unit 40 and the second ultrasonic unit 50 receives the reflection waves, or only one of the first ultrasonic unit 40 and the second ultrasonic unit 50 receives the reflection waves, the detection module 101 determines that there is no object 3 touching the mouse pad 1, and continues to await detection.

The selection module 102 selects a predetermined number of reflection waves from all of the received reflection ultrasonic signals when the object 3 is touching the mouse pad 1. In the illustrated embodiment, the selected reflection waves include a number of first reflection waves generated due to the first ultrasonic waves being reflected by the object 3, and a number of second reflection waves generated due to the second ultrasonic waves being reflected by the object 3. Different reflection waves are reflected from different points of the object 3.

The first ultrasonic waves and the second ultrasonic waves are reflected by the object 3 when the first ultrasonic unit 40 and second ultrasonic unit 50 scan the object 3. In the illustrated embodiment, each position on the object 3 reflecting an ultrasonic wave is a reflection point. Due to the scanning periods of the first ultrasonic waves and the second ultrasonic waves being very short, during one period when the object 3 touches a position of the mouse pad 1, the first ultrasonic waves and the second ultrasonic waves scan and reflect from different positions on the object 3 in sequence.

In the illustrated embodiment, the number of selected first reflection waves and the number of selected second reflection waves both can be default values, such as five. In other embodiments, the number can be predetermined by users.

FIG. 3 illustrates reflection points on the object 3 which is currently touching the mouse pad 1. The calculating module 103 establishes a rectangular coordinates system which is mapped to the mouse pad 1, and determine coordinate values of the first reflection points corresponding to the first reflected waves, and of the second reflection points corresponding to the second reflection waves. In the illustrated embodiment, the rectangular coordinates system is a virtual system.

As illustrated in FIG. 2, the calculating module 103 defines the first position 60 as an origin of the rectangular coordinates system. A line starting from the first position 60 and along the first side 110 is defined as an x-axis of the rectangular coordinates system, and a line starting from the first position 60 and along the second side 120 is defined as a y-axis of the coordinates system, thus establishing the rectangular coordinates system. In the illustrated embodiment, a length of the mouse pad 1 is taken as x and a width of the mouse pad 1 is taken as y. The coordinate value of the first ultrasonic unit 40 is thus (0, 0) and the coordinate value of the second ultrasonic unit 50 is thus (x, 0). The calculating module 103 calculates the coordinate values of the first reflection points and the second reflection points according to the coordinate values of the first ultrasonic unit 40 and the second ultrasonic unit 50.

In one embodiment, when the first ultrasonic unit 40 or the second ultrasonic unit 50 receives the reflection ultrasonic signals, the calculating module 103 determines a distance between a reflection point and the corresponding ultrasonic unit according to a propagation speed of the ultrasonic wave and a time interval to receiving a reflection wave. In addition, the calculating module 103 further determines a transmission angle of the corresponding ultrasonic wave when the first ultrasonic unit 40 or the second ultrasonic unit 50 receives the reflection ultrasonic signals. The position of the reflection point reflecting the corresponding ultrasonic wave with the transmission angle is determined according to the determined distance and the corresponding transmission angle. The calculating module 103 calculates the coordinate values of the first reflection points and the second reflection points in this way.

In the illustrated embodiment, the first ultrasonic unit 40 and the second ultrasonic unit 50 transmit the ultrasonic waves along the first predetermined direction and along the second predetermined direction by a predetermined incremental angle, such as 0.5 degrees angle. The propagation speed of the ultrasonic wave is fast, thus the receipt of a reflection wave after transmitting the ultrasonic wave with a certain transmission angle can establish the transmission angle of the first ultrasonic unit 40 or the second ultrasonic unit 50 as equivalent to the angle of a previously transmitted ultrasonic wave.

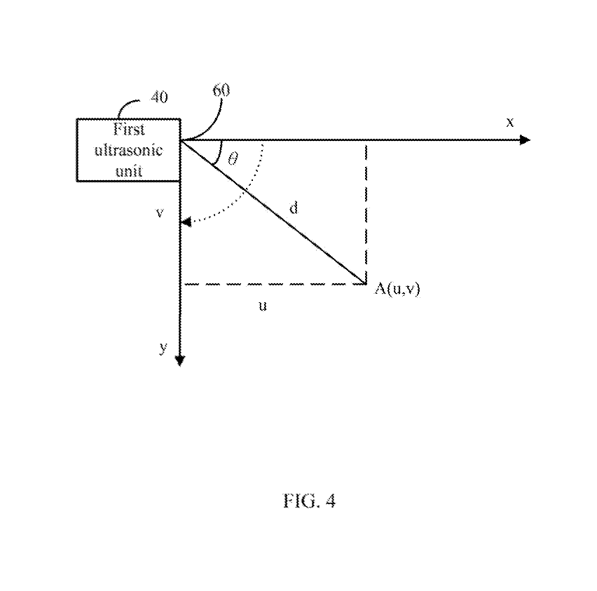

As illustrated in FIG. 4, for example, after transmitting the first ultrasonic wave with an angle θ, the first ultrasonic unit 40 receives the first reflection wave before rotating to a next angle. The received first reflection wave establishes the transmission of the first ultrasonic wave with the angle θ, thus the transmission angle is determined as θ. The interval angle of transmission for scanning is a constant value, and the scanning period also is a constant value, the time when the first ultrasonic unit 40 or the second ultrasonic unit 50 transmits the ultrasonic wave at each angle can also be acquired.

The calculating module 103 determines the time when the first ultrasonic wave was transmitted with the angle θ, and the time when the corresponding first reflection wave was received. The time interval between transmitting the first ultrasonic wave and receiving the corresponding first reflection wave is thus determined, the calculating module 103 further determines the distance d between the first ultrasonic unit 40 and the reflection point A according to the time interval and the propagation speed of the ultrasonic wave. The calculating module 103 calculates the coordinate value of the reflection point A according to the coordinate value of the first ultrasonic unit 40, the angle θ, and the distance d. For example, assuming that the coordinate value of the reflection point A is (u, v), the calculating module 103 calculates the values of u and v according to a first equation tgθ=v/u, and a second equation u²+v²=d².

The determining module 104 determines the reflection points having the same coordinate value at a first predetermined interval according to the coordinate values of all of the first reflection points and the second reflection points. The determining module 104 further selects a single reflection point from the reflection points having the same coordinate value as a detection point, and determines the coordinate value of the detection point. In the illustrated embodiment, the detection point represents the position of the object 3. The determining module 104 further can determine a number of detection points when the object 3 is moving, and can determine a track of motion of the object 3 according to changes of the coordinate values of the number of detection points. When the object 3 does not move, the number of the detection points determined by the determining module 104 is only one and the coordinate value of the detection point does not change. In the illustrated embodiment, the predetermined interval is an integer multiple of the scanning period, such as 0.1 second.

A description of obtaining the detection point follows. For example, assume that the coordinate values of five corresponding first reflection points which are calculated by the calculating module 103 are A(x₁, y₁), B(x₂, y₂), C(x₃, y₃), D(x₄, y₄), and E(x₅, y₅). Assume also that the coordinate values of five corresponding second reflection points which are calculated by the calculating module 103 are A₁(x′₁, y′₁), B₁(x′₂, y′₂), C₁(x′₃, y′₃), D₁(x′₄, y′₄), and E₁(x′₅, y′₅).

When the number of reflection points on the object 3 having the same coordinate value is an odd number, the determining module 104 determines the reflection point in the middle position as being the detection point on the object 3. As illustrated in FIG. 3, in the illustrated embodiment, the coordinate values of point A, point B, and point C are respectively the same as the coordinate values of point A₁, point B₁, and point C₁. Point A and point A₁ are the reflection points having a first same coordinate values, point B and point B₁ are the reflection points having a second same coordinate values, and point C and point C₁ are the reflection points having a third same coordinate values. Where the three points having the first same coordinate values, the second same coordinate values, and the third same coordinate values are scanned by the first ultrasonic unit 40 and the second ultrasonic unit 50, the determining module 104 will determine point A at the middle position as being the detection point on the object 3.

When the number of reflection points having the same coordinate value on the object 3 is an even number, the determining module 104 determines the left reflection point from the two reflection points in the middle position as the detection point on the object 3. In the illustrated embodiment, the coordinate values of point A, point B, point C, and point D are respectively the same as the coordinate values of point A₁, point B₁, point C₁, and point D₁. Point A and point A₁ are the reflection points having a first same coordinate value, point B and point B₁ are the reflection points having a second same coordinate value, point C and point C₁ are the reflection points having a third same coordinate value, and point D and point D₁ are the reflection points having a fourth same coordinate value. Where the four points having the first same coordinate values, the second same coordinate values, the third same coordinate values, and the fourth same coordinate values are scanned by the first ultrasonic unit 40 and the second ultrasonic unit 50, then because point A and point B are in the middle position, the determining module 104 will determine that point B, which is the left reflection point, is the detection point on the object 3.

In other embodiments, when the number of reflection points having the same coordinate value on the object 3 is an even number, the determining module 104 can also determine that the right reflection point (from the two reflection points in the middle position) is the detection point on the object 3.

When there are no reflection points having the same coordinate value in the first reflection points and the second reflection points, the selection module 102 reselects a number of first reflection points and a number of second reflection points, until reflection points having the same coordinate value are found.

In one embodiment, the determining module 104 also can determine a number of coordinate value ranges, each including a number of first reflection points and second reflection points, according to the coordinate values of the first reflection points and the second reflection points at a second predetermined interval. The determining module 104 determines whether there are at least two reflection points having the same coordinate value in each range, and determines upon one reflection point, from the at least two reflection points having the same coordinate value, as being the detection point, when there are at least two reflection points having the same coordinate value in the range. When there are no reflection points having the same coordinate value in the range, the selection module 102 reselects a number of first reflection points and a number of second reflection points in the range.

In the foregoing manner, the determining module 104 can determine the corresponding detection points on a variety of objects 3, and determine a number of detection points on one object 3, and further determine the track of motion of each object 3 according to the changes of the coordinate values of the respective detection points. A multiple-touch detection function is thus achieved.

In another embodiment, the determining module 104 can calculate an average coordinate value of all of the first reflection points and the second reflection points, and determine the reflection point having the average coordinate value as the detection point. The determining module 104 can determine a number of coordinate value ranges, calculate the average coordinate value in each coordinate value range, and determine the reflection point having the average coordinate value as being the detection point on the object 3. Similarly, corresponding detection points on a variety of objects 3 can be determined.

The determining module 104 further determines the track of motion of the object 3 according to the changes of the coordinate values of the detection point of the object 3, and the definition module 105 defines corresponding mouse actions, thus causing the electronic device 2 to execute functions corresponding to the defined mouse actions.

In one embodiment, when the determining module 104 determines the detection point on the object 3, the first ultrasonic unit 40 and the second ultrasonic unit 50 continue to transmit the first ultrasonic waves and the second ultrasonic waves. Detection points on the object 3 are continually determined by the determining module 104, as are the current coordinate value of each detection point and the track of motion of the object 3 according to the changes of the coordinate values of the detection points. In all these situations, the definition module 105 can define the corresponding mouse actions.

When determining that the coordinate values of one detection point are changing continuously, the determining module 104 determines the direction and extent of motion of the detection point according to the changes of the coordinate values of the detection point. The definition module 105 defines the mouse action as a moving action when the determining module 104 determines that one detection point is moving, thus causing the electronic device 2 to control a cursor to execute the move action according to the direction and extent of motion of the detection point.

When the detection module 101 detects that the first ultrasonic unit 40 or the second ultrasonic unit 50 are not receiving the reflection waves, the determining module 104 cannot determine the coordinate value of one detection point. This represents a situation where there is no object 3 touching the mouse pad 1, thus the detection point disappears. When the detection module 101 detects the reflection waves from the first ultrasonic unit 40 and the second ultrasonic unit 50, and the determining module 104 can determine the coordinate value of the detection point after a period of time, there is or are objects 3 touching the mouse pad 1, thus the detection point reappears.

In the illustrated embodiment, the definition module 105 further defines the mouse action as a click action when the determining module 104 determines that one detection point appears then disappears within a first predetermined time duration, thus causing the electronic device 2 to execute the click action, the click action may be to select a target object displayed by the electronic device 2.

The definition module 105 further defines the mouse action as a double-click action when the determining module 104 determines that one detection point appears, then disappears, and then reappears within a second predetermined time duration, thus causing the electronic device 2 to execute the double-click action on a displayed and selected object, such as to open the object. In the illustrated embodiment, the first predetermined time duration and the second predetermined time duration can be determined by the user. The first predetermined time duration can be 0.5 seconds, the second predetermined time duration can be 1 second.

Furthermore, the definition module 105 further defines the mouse action as a right-click action when the determining module 104 determines that two detection points appear and then disappear at the same time within the first predetermined time duration, thus causing the electronic device 2 to execute the right-click action to view the properties of a displayed and selected object.

The definition module 105 further defines the mouse action as a dragging action when the determining module 104 determines that the coordinate values of two detection points have changed to the same extent, thus causing the electronic device 2 to execute the drag action to a displayed and selected object. In the illustrated embodiment, the object can be an icon, a file, or a folder.

The sending module 106 sends information about the defined mouse actions to the electronic device 2 via the communication unit 30, and the electronic device 2 analyzes the information about the mouse action to recognize the mouse actions, and further executes the required functions. In other embodiments, the sending module 106 also can send the track of motion information to the electronic device 2, and the electronic device 2 defines corresponding mouse actions according to the foregoing method, and further executes the required functions.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A mouse pad with a touch detection function comprising:
a communication unit configured to connect to an electronic device;
a first ultrasonic unit configured to transmit a first ultrasonic wave towards the mouse pad, the first ultrasonic wave having a transmission angle gradually changing along a first predetermined direction periodically;
a second ultrasonic unit configured to transmit a second ultrasonic wave towards the mouse pad, the second ultrasonic wave having a transmission angle gradually changing along a second predetermined direction periodically;
a storage device configured to store one or more programs; and
at least one processor configured to execute the one or more programs, which cause the processor to:
detect whether the first ultrasonic unit and the second ultrasonic unit receive reflection waves;
when the first ultrasonic unit and the second ultrasonic unit both receive the reflection waves, determine that an object is touching the mouse pad;
when the object is touching the mouse pad, select a predetermined number of reflection waves from all of the received reflection ultrasonic signals, wherein the selected reflection waves comprise a plurality of first reflection waves generated due to the first ultrasonic waves being reflected by the object, and a plurality of second reflection waves generated due to the second ultrasonic waves being reflected by the object;
establish a rectangular coordinates system which is mapped to the mouse pad;
determine coordinate values of the first reflection points corresponding to the first reflected waves and of the second reflection points corresponding to the second reflection waves;
determine the reflection points having the same coordinate value at a first predetermined interval according to the coordinate values of all of the first reflection points and the second reflection points;
select a single reflection point from the determined reflection points having the same coordinate value as a detection point; and
determine the coordinate value of the detection point.

2. The mouse pad according to claim 1, wherein the at least one processor is caused to:
determine a distance between a reflection point and the corresponding ultrasonic unit according to a propagation speed of the ultrasonic wave, and a time interval to receiving a reflection wave;
determine a transmission angle of the corresponding ultrasonic wave when the first ultrasonic unit or the second ultrasonic unit receives the reflection ultrasonic signals; and
determine the position of the reflection point reflecting the corresponding ultrasonic wave with the transmission angle according to the determined distance and the corresponding transmission angle.

3. The mouse pad according to claim 2, wherein the at least one processor is caused to:
when the number of reflection points on the object having the same coordinate value is an odd number, determine the reflection point in the middle position as being the detection point on the object; and
when the number of reflection points on the object having the same coordinate value is an even number, determine the left reflection point from the two reflection points in the middle position as being the detection point on the object.

4. The mouse pad according to claim 3, wherein the at least one processor is caused to:
determine a plurality of coordinate value ranges, each comprising a plurality of first reflection points and second reflection points according to the coordinate values of the first reflection points and the second reflection points at a second predetermined interval; and
determine upon one reflection point from at least two reflection points having the same coordinate value as the detection point.

5. The mouse pad according to claim 2, wherein the first ultrasonic unit and second ultrasonic unit transmit the ultrasonic waves along the first predetermined direction and along the second predetermined direction by a predetermined incremental angle, the receipt of a reflection wave after transmitting the ultrasonic wave with a certain transmission angle is capable of establishing the transmission angle of the first ultrasonic unit or the second ultrasonic unit as equivalent to the angle of a previously transmitted ultrasonic wave, the at least one processor is caused to:
determine the time interval between transmitting the first ultrasonic wave and receiving the corresponding first reflection wave;
determine the distance between the first ultrasonic unit and the reflection point according to the time interval and the propagation speed of the ultrasonic wave; and
calculate the coordinate value of the reflection point according to the coordinate value of the first ultrasonic unit, the angle, and the distance.

6. The mouse pad according to claim 1, wherein the at least one processor is further cause to:
when determining that one detection point is moving, define a mouse action as a moving action.

7. The mouse pad according to claim 6, wherein the at least one processor is further caused to:
when determining that one detection point appears then disappears within a first predetermined time duration, define the mouse action as a click action.

8. The mouse pad according to claim 6, wherein the at least one processor is further caused to:
when determining that one detection point appears, then disappears, and then reappears within a second predetermined time duration, define the mouse action as a double-click action.

9. The mouse pad according to claim 6, wherein the at least one processor is further caused to:
when determining that two detection points appear and then disappear at the same time within the first predetermined time duration, define the mouse action as a right-click action.

10. The mouse pad according to claim 6, wherein the at least one processor is further caused to:
when determining that the coordinate values of two detection points have changed to the same extent, define the mouse action as a dragging action.

11. The mouse pad according to claim 6, wherein the at least one processor is further caused to:
send information about the defined mouse actions to the electronic device via the communication unit, for the electronic device recognizing the mouse action and executing the required functions.
